(19) United States
(12) Patent Application Publication
(10) Pub. No.: US 2006/0147341 A1
(43) Pub. Date: Jul. 6, 2006

(54) Article and method for detecting skin irritants

(76) Inventors: Edwin G.E. Jahngen, Kingston, NH (US); Arthur J. Meuse, Lynnfield, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/027,321

(22) Filed: Dec. 30, 2004

(51) Int. Cl. G01N 31/22

(52) U.S. Cl. 422/56

(57) ABSTRACT

An article and method for detecting the presence of skin irritants on a surface. The article comprises cyclodextrin and an indicator. The indicator is configured to react with a polyhydroxyaromatic skin irritant to provide indicia of the presence of the polyhydroxyaromatic skin irritant.

### BACKGROUND

1. Field of Invention

This invention relates generally to an article and method for detecting the presence of a skin irritant, and more particularly, to an article and method for detecting a polyhydroxyaromatic skin irritant.

2. Discussion of Related Art

Exposure to naturally occurring skin irritants is a common hazard associated with outdoor activities. Contact with plants of the botanical family Anacardiaceae, and more particularly with the genus Toxicondendron, often causes a dermatological reaction, such as contact dermatitis. The plants, including poison ivy, poison oak, poison sumac, the lacquer tree, mango and cashew, belong to a group of plants with urushiols which typically irritate the skin.

About 80-90% of adults will get a rash if exposed to 50 micrograms of purified urushiol, which is a minute amount when considering that one grain of table salt weighs about 60 micrograms. Urushiol is a relatively stable compound which may remain potent for months or years in the absence of oxidation or polymerization. Contact with 100 year old herbarium specimens has caused contact dermatitis. Urushiols are also easily transferred to an individual from the contaminated fur of animals and from the surface of contaminated objects, such as clothes, tools and equipment.

Treating a contaminated surface, such as by washing, is an accepted practice. U.S. Pat. No. 5,409,908 to Sanchez et al. discloses a method of removing urushiols from a surface by binding the urushiols to cyclodextrins.

Early treatment, that is before the onset of symptoms, is desirable, However, such treatment is predicated upon knowing that actual contact with the toxic plants has occurred. Unfortunately, it may not be readily apparent to an individual that he or she has come into contact with these toxic plants. For example, poison ivy resembles other harmless plants so that an individual may not realize there has been contact. Moreover, contact with urushiols does not result in an immediate skin irritation. It is not uncommon for the first symptom, typically itching, to manifest itself between about 6 hours and about 24 hours after contact. Additional symptoms, such as redness and swelling may not occur for up to 48 hours after contact, followed eventually by the formation of microblisters.

U.S. Pat. No. 4,472,507, issued to Pluim, Jr., discloses a method for detecting exposure to poison ivy and the like. An indicator comprises a carrier treated with a reactant, such as ferric nitrate, which reacts with the toxin to produce a color change indicative of such contact.

### SUMMARY OF INVENTION

The invention is directed to an abrasive article comprising abrasive material deposited on an adhesive configured in an identifying pattern on a substantially planar substrate. The identifying pattern corresponds to a characteristic of the coated abrasive article.

One embodiment is directed to an article for detecting the presence of a polyhydroxyaromatic skin irritant on a surface. The article comprises cyclodextrin configured to bind at least a portion of a polyhydroxyaromatic skin irritant present on the surface to at least a portion of the cyclodextrin, and an indicator in communication with the cyclodextrin and configured to react with the polyhydroxyaromatic skin irritant to provide indicia of the presence of the polyhydroxyaromatic skin irritant.

Another embodiment is directed to a kit for detecting the presence of a polyhydroxyaromatic skin irritant on a surface. The kit comprises a substrate comprising cyclodextrin configured to bind at least a portion of a polyhydroxyaromatic skin irritant present on the surface to at least a portion of the cyclodextrin, and a reservoir comprising an indicator in communication with the cyclodextrin and configured to react with the polyhydroxyaromatic skin irritant to provide indicia of its presence.

Another embodiment is directed to a method of determining the presence of urushiol on a surface comprising the acts of contacting a substrate comprising cyclodextrin with a surface, binding at least a portion of the a urushiol present on the surface to at least a portion of the cyclodextrin, and exposing an indicator to at least a portion of the urushiol bound to the cyclodextrin. The indicator is configured to react with the urushiol.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a side view of one embodiment of the present invention.

FIG. 2 is a schematic view of one embodiment of the invention.

FIG. 3 is a graph of average percent response verses concentration of toxin.

FIG. 4 is a schematic view of another embodiment of the present invention.

FIG. 5 is a graph of average percent response verses concentration of cyclodextrin.

FIG. 6A is a graph of average percent response verses concentration of Ferric Chloride.

FIG. 6B is a graph of average percent response verses concentration of Ferric Citrate.

FIG. 7 is a graph of average percent response of various substrates.

FIG. 8 is a graph of average percent response verses concentration of methyl catechol and 4-t-butyl catechol.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The present invention relates to a composition and method for detecting the presence of polyhydroxyaromatic skin irritants commonly found in plants known to cause skin irritations, such as contact dermatitis. These plants, typically from the genus Toxicondendron of the Anacardiaceae family, contain urushiols which often irritate exposed skin. For example, contact with the sap or oils of poison ivy, poison oak, poison sumac, the lacquer tree, mango, and cashew, is known to cause contact dermatitis. In one embodiment, the present invention provides a point of contact test that may be used by an untrained user in the field. Field use may also provide the user with immediate results, allowing the user to take preventative measures to avoid developing contact dermatitis, such as washing or changing clothes, in the event of a positive response indicating actual exposure to polyhydroxyaromatic skin irritants.

Urushiol is a generic term applied to the toxic substance in the sap or oil of a plant, and is commonly a mixture polyhydroxyaromatic compounds called catechols. Catechols are 1,2 dihydroxy-phenyls with typically a 15 or 17 carbon atom aliphatic side chain with various degrees of unsaturation. For example, poison oak urushiol contains primarily 17 carbon side-chains catechols or heptadecylcatechols. Poison ivy and poison oak urushiols contain primarily 15 carbon side-chains catechols, or pentadecylcatechols. The aliphatic hydrocarbon side group allows bonding to, and penetration of, the skin. The hydrocarbon side chain is hydrophobic, and the dihydroxy phenyl moiety is hydrophilic.

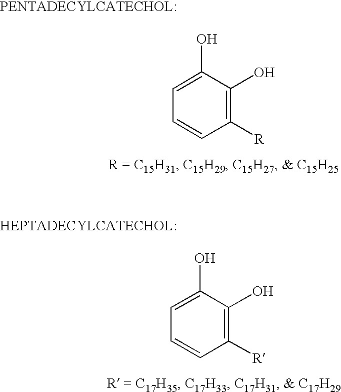

The present invention comprises cyclodextrin and an indicator capable of producing indicia, or a perceivable change, when contacted with the polyhydroxyaromatic skin irritants. Any cyclodextrin may be used in the present invention. Cyclodextrins are nonreducing cyclic oligosaccharides that are synthesized from starch by enzymes called cyclomaltrodextrin glucanosyltransferase. Cyclodextrins are most commonly composed of six to twelve D-glucose residues, although larger rings have been synthesized. α-Cyclodextrin consist of six glucose residues, β-cyclodextrin consists of seven glucose residues, and γ-cyclodextrin consists of eight glucose residues. Water solubility is generally higher for rings having an even number of glucose residues. In a preferred embodiment, the cyclodextrin is β-cyclodextrin.

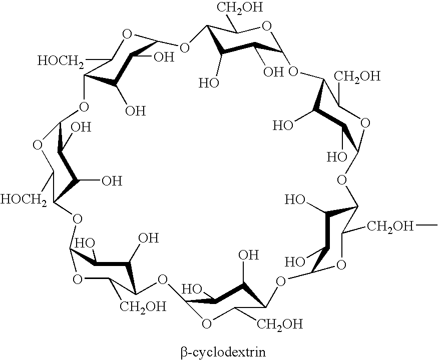

Because the hydroxyl groups in cyclodextrin project outward, the outer surface is hydrophilic, while the cavity is relatively more hydrophobic. Cyclodextrins have a rigid conical shape. The three dimensional shape of cyclodextrin is represented below.

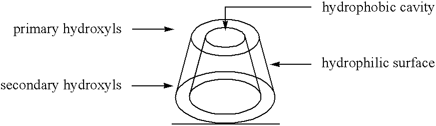

Cyclodextrin may be applied to a substrate to immobilize the urushiols to a specific location on the substrate. The Cyclodextrin may be deposited on a surface of the substrate, and/or deposited throughout the substrate, such as by immersing the substrate in a solution containing Cyclodextrin.

The substrate may be any material having a surface suitable for carrying cyclodextrin. Examples of substrates include, but are not limited to, a polymer sheet, fibrous sheet, fabric, paper, sponge, gauze, swab, gel, foam, a natural or synthetic woven or nonwoven, and the like. In a preferred embodiment, the substrate provides an outer surface for supporting the Cyclodextrin, while also providing an interior portion to absorb fluids, such as carrier solvents. Absorption of carrier solvent(s) in an inner portion of the substrate may wick the carrier solvent(s) away from the outer surface of the substrate while maintaining the reaction between the Cyclodextrin and the indicator at or near the surface of the substrate. By maintaining the reaction at or near the surface of the substrate, the reaction product may be easily detected. In a preferred embodiment, the substrate is gauze, more preferably a swab having a high density absorbent tip, such as Rayon.

The substrate may be configured to be removably attachable to a subject. As used herein, the term “subject” is used to define any person or animal that may have contacted, or has the potential to contact, urushiol containing plants. The substrate containing cyclodextrin may be positioned upon the individual or animal, thereby coming into direct contact with area vegetation, allowing the cyclodextrin on the substrate to bind with urushiols from toxic plants. The substrate may be directly and/or indirectly attached to the subject. The substrate may be configured to be removably attachable to an article worn by the individual or animal, such as sock, shoe, pants, shorts, shirt, collar, and bandana. The substrate may also be configured to be removably attachable directly to the subject's skin or fur.

The substrate need not be worn, but may be configured to be used by an individual after potential exposure to urushiol containing plants, or for direct identification of urushiol containing plants. For example, the substrate may be configured to be used as a wipe, which may be used to collect urushiols that have transferred to the individual or animal and may be used to sample a number of different surfaces with one substrate. A single wipe type substrate may be contacted with the skin of the legs, arms, and hands as well as with clothing worn by the individual. Similarly, the wipe type substrate may be contacted with the collar, bandana, and legs of an animal. The use of a wipe type substrate allows an individual to examine a larger area of potential contact with urushiols than a stationary substrate that is worn in one location. The ability to examine a number of different surfaces to produce a single point reaction may result in a more representative indication of exposure to urushiols. The substrate may be, but need not be, reusable in the event that a previous use indicated that urushiols are not present and therefore no indicia was formed. A positive indication of the presence of urushiol affords the subject the opportunity to take preventative measures, such as washing and or changing clothing.

The substrate may, but need not, be moistened by a liquid, gel, or foam. The liquid may be any liquid or solution that aids in the removal of urushiols from the surface of the subject and in the transfer of the urushiols to the surface of the substrate for reaction with the cyclodextrin present on the surface of the substrate. The liquid may be solvent or water based. In one embodiment, a 15% isopropanol in water solution containing cyclodextrin is applied to the substrate.

The indicator may be any compound capable of reacting with polyhydroxyaromatic compounds to produce indicia of the presence of a polyhydroxyaromatic compound. The indicia formed may be detected by any of the five senses. For example, a visible change, such as color or fluorescence, and/or a tactical change such as texture, may occur upon reaction between the indicator and the polyhydroxyaromatic compounds. Alternatively, or in addition to visible/tactile changes, the reaction may cause the formation of a particular aroma.

In one embodiment of the invention, the indicia is represented by the formation of color. Examples of indicators which form a visible color change when reacted with the polyhydroxyaromatic compounds include, but are not limited to, metal salts, such as ferric salts, salts of chromium, silver, and copper, diazammonium salts, and combinations thereof. In one embodiment, the indicator may be selected from the group consisting of: ferric citrate, ferric chloride, and ferric nitrate and combinations thereof, preferably ferric citrate, ferric chloride, and combinations thereof. In a preferred embodiment, a color change is formed by the reaction between Fe⁺³ and the polyhydroxyaromatic compounds.

The indicator may be in a liquid carrier that may be applied to the substrate, the surface of a subject, and/or directly a surface of a plant. The liquid may, but need not, assist in solubilzing urushiol, and may be water or solvent based. In one embodiment, the liquid carrier is selected to wet both the surface of the substrate and the cyclodextrin. The liquid carrier may also comprise a hydrophobic component to assist in contacting the indicator with the cyclodextrin. In one embodiment, the liquid carrier is a solution of water and isopropyl alcohol. In a preferred embodiment, the liquid carrier is a 15% isopropanol in water solution.

In one embodiment of the invention, a portion of the indicator from a reservoir is contacted with the substrate. The indicator may be applied to the substrate after the substrate is contacted with a surface that may be contaminated with urushiol, or prior to contact with the surface that may be contaminated with urushiol. Alternatively, the indicator may be applied directly to a surface believed to have urushiols thereon. The indicator may be applied to the various surfaces by conventional methods, such as by droplet, immersion, brush, roller, spray, and the like.

The indicator and the substrate comprising the cyclodextrin may be supplied in one article. Alternatively, the indicator and the substrate may be individual components to a kit. One embodiment utilizes an absorbent tipped swab having a hollow tube adjacent the tip, such as swabs manufactured by Swabplus, Inc., of Rancho Cucamonga, Calif. In one embodiment, the absorbent tip may comprise a foam, or a natural or synthetic woven or nonwoven material. The absorbent tip may be coated with cyclodextrin, and the hollow tube may house a liquid indicator. A user may contact the tip with several surfaces believed to have been exposed to urushiols, and then break the tube allowing the liquid indicator to flow into the absorbent tip. The formation of indicia indicates the presence of urushiol on the absorbent tip, and therefore, on one or more surfaces contacted with the absorbent tip.

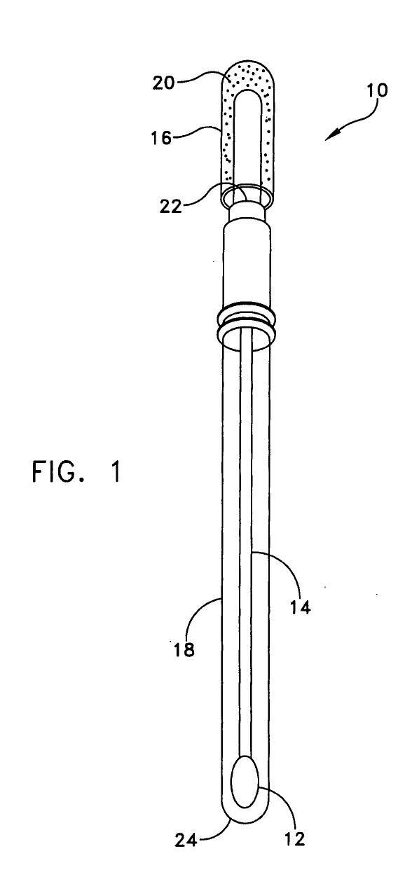

Another embodiment, similar to swabs provided by Medical Packaging, Inc. (Camarillo, Calif.) is shown in FIG. 1. Swab 10 comprises an absorbent tip 12 positioned at one end of a rod or tube 14. A fluid tight compartment 16 is positioned at another end of the rod or tube 14 opposite the absorbent tip 12. A sleeve 18, sealed at one end, removably encases the absorbent tip 12. The absorbent tip 12 may be formed of a natural or synthetic woven, non-woven, foam, or combinations thereof The absorbent tip 12 may be coated with cyclodextrin. The fluid tight compartment 16 may house a liquid indicator 20, such as ferric chloride in water with about 0 wt % to about 30 wt % of a water soluble organic modifier such as acetone, methanol, ethanol, propanol, and combinations thereof. The absorbent tipped tube may be removed from the sleeve 18 and contacted with one or more surfaces believed to have been exposed to urushiols. The absorbent tipped tube may then be repositioned within the sleeve 18, and a seal 22 positioned between the tube 14 and the fluid tight compartment 16 may be broken releasing the indicator 20 to the sleeve 18. The indicator 20 may flow into the sleeve 18 through a center channel of the tube (not shown) and through the absorbent tip 12. Alternatively, the indicator may flow along an outer surface of the tube 14 to the absorbent tip 12. Excess indicator may collect at the closed end 24 of the sleeve 18. Presence of urushiol may be indicated by a color change to the absorbent tip and/or to the indicator fluid 20 collected in the closed end 24 the sleeve. The indicator in the sleeve 18 may be shaken to increase the reaction between the urushiol and the indicator 20, thereby enhancing the color change. In another embodiment, the indicator may be positioned at the closed end 24 of the sleeve 18 and the fluid tight compartment 16 may house an inert solution. When released as noted above, the solution may dissolve the indicator 20, such as ferric chloride, causing the indicator to contact the absorbent tip 24 and any urushiol present.

The use of the cyclodextrin may enhance the perceivable response of the reaction between the urushiol and the indicator by orientating the molecule by self-assembly, so that the reactive hydrophilic dihydroxy phenyl moiety may be at or near the surface and the hydrophobic hydrocarbon chain may be buried in the core of the cyclodextrin. When absorbent substrates are used, the presence of cyclodextrins on the surface of the substrate may prevent the urushiols from wicking away from the surface, thereby localizing the presence of urushiols.

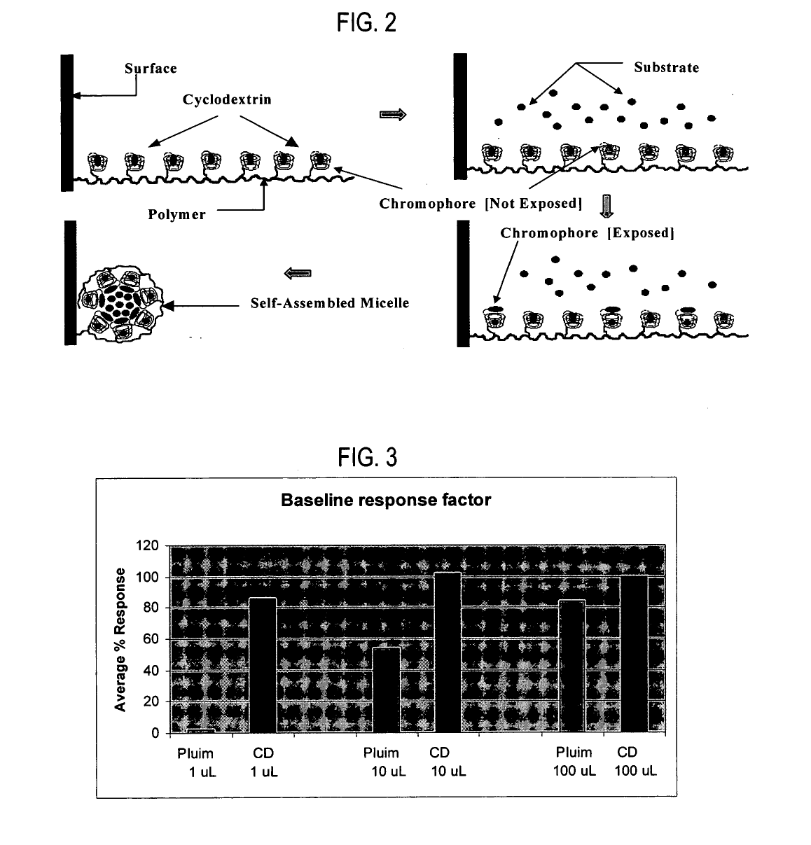

In another embodiment, a hydrophilic polymer bearing pendant cyclodextrin rings may be used in the present invention. When a sufficient number of cyclodextrin rings are in the complexed form, that is reacted with urushiol, self-assembly will occur as illustrated in FIG. 2. The self-assembly of the cyclodextrin containing urushiol may increase the density of the dihydroxy phenyl moiety at the surface, enhancing the detection with the indicator.

In another embodiment, the cyclodextrin may be complexed with an unexposed chromophore. A hydrophobic molecule, such as a chromophore or a fluorescent molecule, may be linked or tethered to the cyclodextrin ring. As shown in FIG. 2, a hydrophobic molecule of appropriate size may penetrate into the hydrophobic cavity, remaining within the cavity in a thermodynamically favored state. Urushiols transferred to a substrate, may compete with the hydrophobic molecule and push the hydrophobic molecule out of the cavity. If the original hydrophobic molecule is a colored chromophore or a fluorescent molecule tethered to the cylcodextrin, it's nascent color or fluorescence will change when it is exposed to the environment.

### EXAMPLES

The invention may be further understood with reference to the following examples, which are intended to serve as illustration only, and not as a limitation of the present invention as defined in the claims herein.

In the following examples, 4-methyl catechol and 4-t-butyl catechol, shown below, were used as analogues of the natural urushiols.

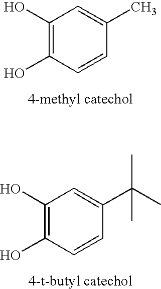

Each catechol was dissolved in 15% isopropanol in water at a concentration of 1.0 g/mL to form a syrup to simulate the toxin. The toxins were reacted with various indicators both in the presence and in the absence of β-cyclodextrin. The reaction between the indicator and the toxin produced a color change. The intensity of the resultant color was recorded by a digital camera and scanned. The scanned images were analyzed with a quantitative densitometry program (SigmaScan® from Systat Software, Inc. of Richmond, Calif.) to determine the relative intensity of the toxin development.

### Example I

Eighteen disks, having a diameter of about 0.5 cm, were prepared from Whatman #41 quantitative ashless filter paper. Nine disks were coated with 200 μL of a solution of β-cyclodextrin and dried. The solution of β-cyclodextrin was prepared by dissolving 500 mg of β-cyclodextrin in 1 mL of a 15% isopropanol in water solution and allowed to dry. The remaining nine disks were not coated with β-cyclodextrin. The coated and uncoated disks were divided into three sets, each set including three coated and three uncoated disks.

Toxin was prepared by mixing 4-methyl catechol with a 15% isopropanol in water solution at a concentration of 1.0 g/mL. Toxin was applied to each disk within each set. The first set of disks received 1 μL of toxin, the second set received 10 μL of toxin, and the third set received 100 μL of toxin.

Each disk was sprayed with ferric chloride at 30% w/v in 15% isopropanol in water causing a dark blue/black spot to form on the surface of the substrate. The intensity of the spot was measured and recorded. Each of the three trials was averaged and the highest response was set at 100%. The results are shown in FIG. 3.

As shown in FIG. 3, the presence of β-cyclodextrin significantly enhances the intensity of the color change. For the set of samples exposed to 100 μL of toxin, the disks coated with β-cyclodextrin had an average percent response of 100, while the uncoated disks had an average percent response of about 82%. The coated disks receiving 100 μL of toxin provide indicia having an intensity of about 22% greater than that of the uncoated disks receiving the same amount of toxin. Similarly, for the set of samples exposed to 10 μL of toxin, the disks coated with β-cyclodextrin had an average percent response of about 102%, while the uncoated disks had an average percent response of about 52%. Again, the disks coated with β-cyclodextrin provided indicia having an intensity of about 96% greater than that of the uncoated disks, when exposed to 10 μL of toxin. When a set of samples was exposed to 1 μL of toxin, the disks coated with β-cyclodextrin had an average percent response of about 83%, while the uncoated disks had an average percent response of only about 2%. At 1 μL of toxin, the coated disks provided indicia having an intensity substantially greater than that of the uncoated disks.

In addition to increasing the intensity of the response, the disks coated with β-cyclodextrin are significantly more sensitive to smaller concentrations of toxin than the uncoated disks. As seen in FIG. 3, the three disks coated with β-cyclodextrin had an average percent response of about 83% when exposed to only 1 μL of toxin, while the three coated disks had a similar average percent response of about 82% only when exposed to 100 μL of toxin. About 100 times the amount of toxin is required to produce a similar response in the uncoated sample, compared to the coated sample.

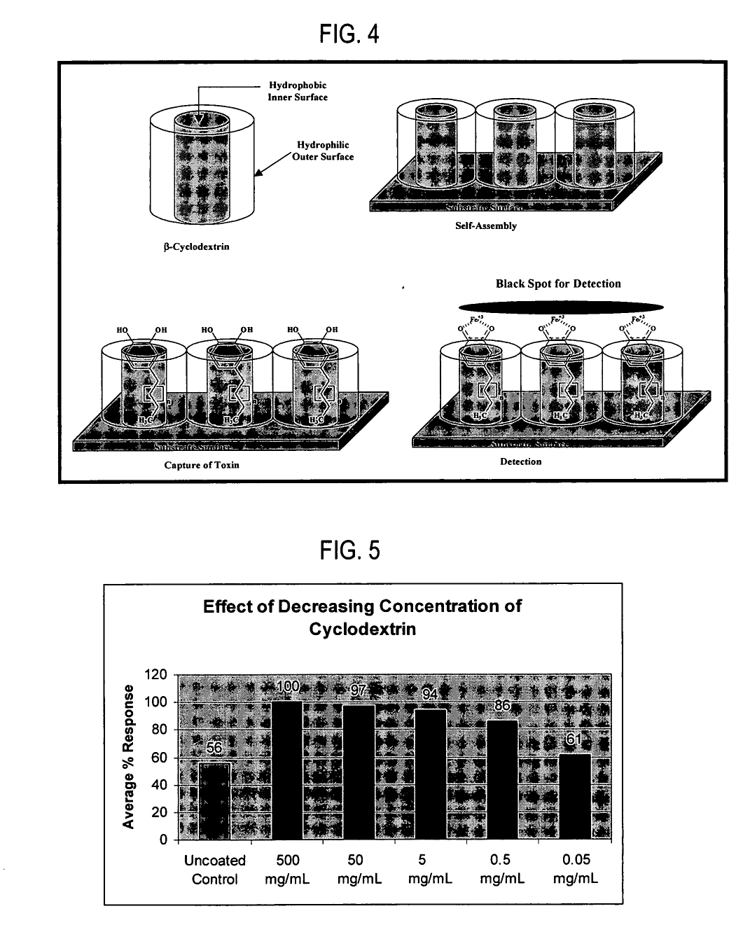

Without being bound to any particular theory, it is believed that the ability of the cyclodextrins to self assemble on the surface coupled with the orientation of the toxin in the cyclodextrin enhances the response to the ferric chloride, as illustrated in FIG. 4.

### Example II

Eighteen disks, having a diameter of about 0.5 cm, were prepared from Whatman #41 quantitative ashless filter paper. The disks were divided into six sets of three, wherein five sets of disks were coated with various concentrations of β-cyclodextrin, while the remaining set remained uncoated. A first set of disks was coated with an original β-cyclodextrin solution containing 500 mg β-cyclodextrin per 1 mL of a 15% isopropanol in water solution. The original β-cyclodextrin solution was diluted in decades so that the second set of disks was coated with a β-cyclodextrin solution of 50 mg/mL, the third set with 5 mg/mL, the fourth set with 0.5 mg/mL, and the fifth set with 0.5 mg/mL. Each set was heated to dry.

Each disk was then exposed to 10 μL of the toxin. The toxin was prepared by mixing 4-methyl catechol in a 15% isopropanol in water solution at a concentration of 1.0 g/mL. Each disk was sprayed with a ferric chloride at 30% w/v in 15% isopropanol in water causing a dark blue/black spot to form on the surface of the substrate. The intensity of the spot was measured and recorded. Each of the three trials was averaged and the highest response was set at 100%. The results are shown in FIG. 5.

As shown in FIG. 5, the disks coated with the greatest amount of β-cyclodextrin (500 mg/mL) exhibited the greatest color intensity, and was given an average percent response of 100%. No significant change in intensity occurred as the concentration of β-cyclodextrin was reduced to 50 mg/mL and 5 mg/mL, wherein the average percent response is 97% and 94%, respectively. As the concentration of β-cyclodextrin was reduced to 0.5 mg/mL, the average percent response was about 86% which is still significantly higher than the average percent response of the uncoated disks, which have an average percent response of about 56%. The intensity of the response of about 61% generated by disks coated with a dilute solution of β-cyclodextrin (0.05 mg/mL) is also higher than the response of the uncoated samples. Although the intensity of the response diminishes with diminishing concentrations of β-cyclodextrin on the surface of the substrate, all coated concentrations of β-cyclodextrin show an improved response over the uncoated samples.

### Example IIIA

Eighteen coated disks, having a diameter of about 0.5 cm, were prepared from Whatman #41 quantitative ashless filter paper. The disks were coated with a β-cyclodextrin solution containing 500 mg β-cyclodextrin per 1 mL of a 15% isopropanol in water solution, and dried. Eighteen uncoated disks of 0.05 cm were also prepared from Whatman # 41 quantitative ashless filter paper. Each coated and uncoated disk was then exposed to 10 μL of the toxin. The toxin was a solution of 4-methyl catechol in a 15% isopropanol in water solution at a concentration of 1.0 g/mL.

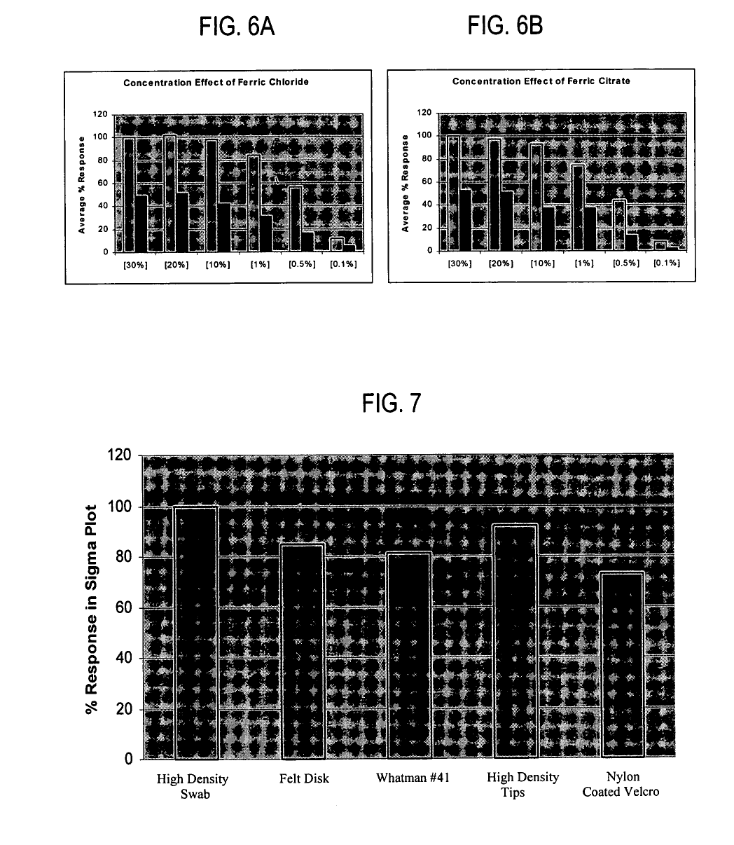

The eighteen coated disks and 18 uncoated disks were then divided into six sets of three coated and three uncoated disks. Each set was then sprayed with varying concentrations of ferric chloride in a 15% isopropanol in water solution. The first set was sprayed with a starting solution of ferric chloride at 30% w/v in 15% isopropanol in water. The starting solution was then diluted by decades so that the second set was sprayed with 20% w/v, the third set with 10% w/v, the fourth set with 1% w/v, the fifth set with 0.05% w/v and the six set with 0.1% w/v. The intensity of the resultant dark blue/black spot was measured and recorded. Each of the three trials was averaged and the highest response was set at 100%. The results are shown in FIG. 6A.

As shown in FIG. 6A, the average percent response of the coated samples was significantly larger than the average percent response of the uncoated samples. The average percent response for a coated disk contacted with 30% ferric chloride is over 50 times greater than the average percent response of the uncoated disk. Even at a ferric chloride concentration of 0.1%, the average percent response for the coated disk is over 200 times greater than the response for the uncoated disk. The presence of β-cyclodextrin enhances the average percent response so that less ferric chloride may be used. Specifically, a ferric chloride concentration of only 0.05% applied to a coated disk produces a greater average percent response than a ferric chloride concentration of 20% and 30% applied to an uncoated disk.

The coated samples are also less sensitive to changes in ferric chloride concentration than the uncoated samples. As shown in FIG. 6A, as the concentration of ferric chloride was diluted from 30% to 10%, the response of the uncoated disks ranged from about 50% to about 42%, which is a decrease in response of about 21%. At similar dilutions of ferric chloride, the response of the coated disks ranged from about 100% to about 99%, which is a decrease in response of only about 2%.

### Example IIIB

Eighteen coated disks and eighteen uncoated disks were prepared according to the procedure of Example IIIA. The disks were then divided into six sets of three coated and three uncoated disks. Each set was then sprayed with varying concentrations of ferric citrate in a 15% isopropanol in water solution. The first set was sprayed with a starting solution of ferric citrate at 30% w/v in 15% isopropanol in water. The starting solution was then diluted by decades so that the second set was sprayed with 20% w/v, the third set with 10% w/v, the fourth set with 1% w/v, the fifth set with 0.05% w/v and the six set with 0.1% w/v. The intensity of the resultant dark blue/black spot was measured and recorded. Each of the three trials was averaged and the highest response was set at 100%. The results are shown in FIG. 6B.

As shown in FIG. 6B, the average percent response of the coated samples was significantly larger than the average percent response of the uncoated samples. The average percent response for a coated disk contacted with 30% ferric citrate is about 50 times greater than the average percent response of the uncoated disk. Even at a ferric citrate concentration of 0.1%, the average percent response for the coated disk is over 300 times greater than the response for the uncoated disk. The presence of β-cyclodextrin enhances the average percent response so that less ferric citrate may be used. Specifically, a ferric citrate concentration of only 0.05% applied to a coated disk produces an average percent response similar to the average percent response of the uncoated disk contacted with than a ferric chloride concentration of 20% and 30%.

The coated samples are also less sensitive to changes in ferric citrate concentration than the uncoated samples. As shown in FIG. 6B, as the concentration of ferric citrate was diluted from 30% to 10%, the response of the uncoated disks ranged from about 50% to about 38%, which is a decrease in response of about 30%. At similar dilutions of ferric chloride, the response of the coated disks ranged from about 100% to about 92%, which is a decrease in response of only about 8%.

A comparison of FIGS. 5A and 5B illustrates that the average percent responses are similar when using an organically derived source of ferric ion from ferric citrate or an inorganically derived source from ferric chloride.

### Example IV

A number of different substrates were coated with a β-cyclodextrin solution, contacted with the toxin (4-methyl catechol) and an indicator (ferric ion). The use of a tightly woven, high density swab aided in contacting the toxin with the β-cyclodextrin. As the toxic solution was applied to the swab, the liquid was absorbed into the swab below the surface, leaving the toxin at the surface with the β-cyclodextrin.

The average percent response for samples prepared from Whatman #41 filter paper, Felt Disks (Boston Felt, East Rochester, N.H.), foams, natural and synthetic high density swabs (Qosina, East Rochester, N.H.) were similar as shown in FIG. 7. The response for the swab was set at 100% and all but one substrate provided a response of at least 80% of the swab, however the average percent response for samples prepared from Velcro coated nylon was less than 80% of that of the swab. It may be that a heavy application of the indicator tended to wash the β-cyclodextrin from the surface of the nylon coated velcro.

### Example VA

A number of disks of 0.05 cm were prepared from Whatman # 41 filter paper, and coated with 200 μL of the original β-cyclodextrin solution of 500 mg β-cyclodextrin per 1 mL of 15% isopropanol in water. The disks were divided into four sets. A first set received 100 mg of the 4-methyl catechol toxin solution, while a second set received 1 mg of the 4-methyl catechol toxin solution. A third set received 100 mg of 4-t-butyl catechol toxin solution, while the other set received 1 mg of the 4-t-butyl catechol toxin solution. A ferric chloride solution was applied to the disk. The average percent response was substantially the same whether the disk received 100 mg of toxin or 1 mg of either toxin.

### Example VB

Nine disks of 0.05 cm were prepared from Whatman # 41 filter paper, and coated with 200 μL of the original β-cyclodextrin solution of 500 mg β-cyclodextrin per 1 mL of 15% isopropanol in water. Each disk was contacted with 100 μL of various concentrations of the toxin. The original concentration of toxin (1 g of 4-methyl catechol per mL of 15% isopropanol in water) was diluted by half decades in the same solvent resulting in concentrations ranging from 100 μg/μL to 0.01 μg/μL. A 30% w/v in 15% aqueous isopropanol solution of ferric chloride was sprayed onto each disk. Each disk was photographed and scanned. The scanned images were analyzed using SigmaScan® as described above. The intensity of the dark blue/black spot was measured and recorded. The above test was replicated twice, and the results of the three runs were averaged and the highest response set at 100%.

As seen in FIG. 7, the average percent response for disks exposed to 100 μg and 50 μg of 4-methyl catechol was about 100%, and decreased to about 85% at 10 μg and to about 62% at 5 μg. The average percent response for disks exposed to 1 μg to 0.1 μg had an average percent response under 20%. No detectable response was observed on disks exposed to 0.05 μg or less.

### Example VC

Nine disks of 0.05 cm were prepared from Whatman # 41 filter paper, and coated with 200 μL of the original β-cyclodextrin solution of 500 mg β-cyclodextrin per 1 mL of 15% isopropanol in water. Each disk was contacted with 100 μL of various concentrations of the toxin. The original concentration of toxin (1 g of 4-t-butyl catechol per mL of 15% isopropanol in water) was diluted by half decades in the same solvent resulting in concentrations ranging from 100 μg/μL to 0.01 μg/μL. A 30% w/v in 15% aqueous isopropanol solution of ferric chloride was sprayed on each disk. Each disk was photographed and scanned. The scanned images were analyzed using SigmaScan® as described above. The intensity of the dark blue/black spot was measured and recorded. The above test was replicated twice, and the results of the three runs were averaged and the highest response set at 100%.

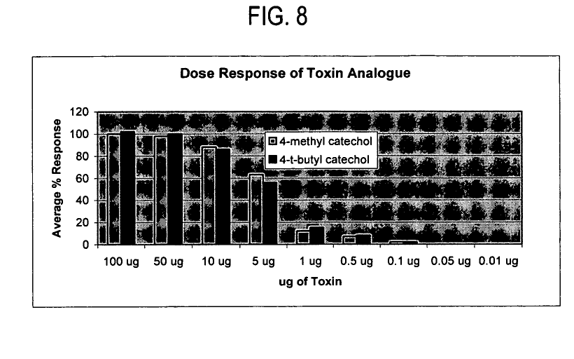

As seen in FIG. 8, the average percent response for disks exposed to 100 μg and 50 μg of 4-t-butyl catechol was about 100%, and decreased to about 84% at 10 μg and to about 58% at 5 μg. The average percent response for disks exposed to 1 μg to 0.1 μg had an average percent response under 20%. No detectable response was observed on disks exposed to 0.05 μg or less.

A comparison of the results in FIG. 7 indicates that the response generated by either toxin (4-methyl catechol and 4-t-butyl catechol) reacting with Fe⁺³ are similar.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An article for detecting the presence of a polyhydroxyaromatic skin irritant on a surface of a subject, the article comprising:
cyclodextrin configured to bind at least a portion of a polyhydroxyaromatic skin irritant present on the surface to at least a portion of the cyclodextrin; and
an indicator in communication with the cyclodextrin and configured to react with the polyhydroxyaromatic skin irritant to provide indicia of the presence of the polyhydroxyaromatic skin irritant.

2. The article of claim 1, wherein the cyclodextrin is supported on a surface of a substrate.

3. The article of claim 1, wherein the cyclodextrin is β-cyclodextrin.

4. The article of claim 2, wherein the substrate is selected from the group consisting of: a swab, gauze, sponge, paper, fabric, polymer sheet, fibrous sheet material, gel, foam, woven material, non-woven material and combinations thereof.

5. The article of claim 2, wherein the substrate is selected from the group consisting of: a natural woven material, a natural non-woven material, a synthetic woven material, a synthetic non-woven material, and combinations thereof.

6. The article of claim 2, wherein the substrate is a swab comprising an absorbent tip positioned at a first end of a tube.

7. The article of claim 6, wherein the swab further comprises a cavity.

8. The article of claim 7, wherein the indicator is positioned within the cavity.

9. The article of claim 6, wherein the absorbent tip is constructed and arranged to maintain a reaction product of the indicator and the polyhydroxyaromatic skin irritant at or near a surface of the absorbent tip.

10. The article of claim 9, wherein the swab further comprises a fluid tight compartment positioned at a second end of the tube.

11. The article of claim 10, further comprising a sleeve surrounding the swab.

12. The article of claim 1, wherein the polyhydroxyaromatic skin irritant is urushiol.

13. The article of claim 12, wherein the urushiol comprises a catechol selected from the group consisting of pentadecylcatechol, heptadecylcatechol, and combinations thereof.

14. The article of claim 1, wherein the indicator is a metal salt.

15. The article of claim 14, wherein the metal salt is a ferric salt.

16. The article of claim 15, wherein the ferric salt is selected from the group consisting of ferric chloride, ferric citrate, and combinations thereof.

17. The article of claim 2, wherein the surface of the substrate comprises a first aqueous solution.

18. The article of claim 17, wherein the first aqueous solution comprises isopropyl alcohol.

19. The article of claim 17, wherein the indicator is dissolved in a second aqueous solution.

20. The article of claim 17, wherein the first and second aqueous solutions are the same aqueous solution.

21. The article of claim 19, wherein the second aqueous solution comprises isopropyl alcohol.

22. The article of claim 2, wherein the subject is selected from the group consisting of animal supplies, outdoor equipment, and combinations thereof.

23. The article of claim 21, wherein the animal supplies are selected from the group consisting of collar, leash, coat, and combinations thereof.

24. The article of claim 21, wherein the outdoor equipment is selected from the group consisting of: gardening equipment, sporting equipment, and camping equipment.

25. The article of claim 1, wherein the surface is skin.

26. The article of claim 1, wherein the surface is an article of clothing.

27. A kit for detecting the presence of a polyhdroxyaromatic skin irritant on a surface comprising:
a substrate comprising cyclodextrin configured to bind at least a portion of a polyhydroxyaromatic skin irritant present on the surface to at least a portion of the cyclodextrin; and
a reservoir comprising an indicator in communication with the substrate and configured to react with polyhydroxyaromatic skin irritant to provide indicia of the presence of the polyhydroxyaromatic skin irritant.

28. The kit of claim 27, wherein the indicator is a metal salt.

29. The kit of claim 28, wherein the metal salt is a ferric salt.

30. The kit of claim 27, wherein the polyhydroxyaromatic skin irritant is urushiol.

31. The kit of claim 30, wherein the urushiol comprises a catechol selected from the group consisting of pentadecylcatechol, heptadecylcatechol, and combinations thereof.

32. The kit of claim 31, wherein the cyclodextrin is β-cyclodextrin.

33. The kit of claim 31, wherein the substrate is selected from the group consisting of: a swab, gauze, sponge, paper, fabric, polymeric sheet, fibrous sheet material, gel, foam, woven material, non-woven material and combinations thereof.

34. The kit of claim 33, wherein the substrate is selected from the group consisting of: a natural woven material, a natural non-woven material, a synthetic woven material, a synthetic non-woven material, and combinations thereof.

35. The kit of claim 33, wherein the substrate is a swab.

36. The kit of claim 33, wherein the substrate is a fibrous sheet material.

37. The kit of claim 27, wherein the cyclodextrin is positioned on a surface of the substrate.

38. The kit of claim 29, wherein the ferric salt is selected from the group consisting of: ferric chloride, ferric citrate, and combinations thereof.

39. The kit of claim 27, wherein the substrate comprises a first aqueous solution.

40. The kit of claim 39, wherein the first aqueous solution comprises isopropyl alcohol.

41. The kit of claim 40, wherein the swab comprises an absorbent tip positioned at a first end of a tube.

42. The kit of claim 41, wherein the reservoir comprises a fluid tight compartment positioned at a second end of the tube.

43. The kit of claim 42, further comprising a sleeve surrounding the swab.

44. The kit of claim 27, wherein the reservoir is supported by a second substrate.

45. The kit of claim 27, wherein the indicator is dissolved in a second aqueous solution.

46. The kit of claim 45, wherein the second aqueous solution includes isopropyl alcohol.

47. The kit of claim 44, wherein the second substrate is selected from the group consisting of: a swab, gauze, sponge, paper, fabric, polymer sheet, fibrous sheet material, gel, foam, woven material, non-woven material and combinations thereof.

48. The kit of claim 47, wherein the second substrate is selected from the group consisting of: a natural woven material, a natural non-woven material, a synthetic woven material, a synthetic non-woven material, and combinations thereof.

49. The kit of claim 47, wherein the second substrate comprises a second aqueous solution.

50. A method of determining the presence of urushiol on a surface comprising the acts of:
contacting a substrate comprising cyclodextrin with the surface;
binding at least a portion of a urushiol present on the surface to at least a portion of the cyclodextrin; and
exposing an indicator to at least a portion of the urushiol bound to the cyclodextrin, the indicator being configured to react with the urushiol.

51. The method of claim 50, further comprising the act of:
detecting an indicia of a reaction between the indicator and the urushiol bound to the cyclodextrin.

52. The method of claim 50, wherein the act of detecting the indicia comprises observing a change in a physical appearance of the substrate.

53. The method of claim 52, wherein the act of detecting the indicia comprises observing a color change on the substrate.

54. The method of claim 50, wherein the act of contacting a substrate comprising cyclodextrin with a surface further comprises contacting the substrate with a first aqueous solution.

55. The method of claim 50, wherein the act of exposing the indicator to at least a portion of the urushiol further comprises exposing the indicator to a second aqueous solution.

56. The method of claim 54, wherein the act of contacting the substrate with a first aqueous solution comprises contacting the substrate with a first aqueous solution comprising isopropyl alcohol.

57. The method of claim 55, wherein the act of contacting the indicator with a second aqueous solution comprises contacting the indicator with a second aqueous solution comprising isopropyl alcohol.
